(19) United States
(12) Patent Application Publication
(10) Pub. No.: US 2003/0058560 A1
(43) Pub. Date: Mar. 27, 2003

(54) Apparatus and method for processing content information capable of time-divisionally carrying out recording and reproducing operations

(75) Inventor: Hirotaka Yamaji, Tokyo (JP)

Correspondence Address: McGinn & Gibb, PLLC, Suite 200, 8321 Old Courthouse Road, Vienna, VA, 22182-3817, US

(73) Assignee: NEC Corporation, Tokyo (JP)

(21) Appl. No.: 10/246,686

(22) Filed: Sep. 19, 2002

(30) Foreign Application Priority Data
Sep. 25, 2001 (JP) 2001-290311

(51) Int. Cl. G11B 5/09; G06F 12/14

(52) U.S. Cl. 360/39; 711/113

(57) ABSTRACT

In a content information processing apparatus including a content information inputting section, a content information storage section, a content information reproducing section, and a content information storage section controlling section, the content information storage section substantially time-divisionally carries out a recording operation upon input content information inputted from the content information inputting section for the storage section and a reproducing operation upon output content information in the storage section for the reproducing section.

### BACKGROUND OF THE INVENTION

1. Field of the Invention

The present invention relates to an appartus and method for processing content information.

2. Description of the Related Art

Generally, in a prior art content information processing apparatus, input content information such as video information and audio information from broadcasting stations or content servers is recorded in a hard disk unit in accordance with users' electric programs (see: JP-A-8-292842).

On the other hand, while content information is being recorded, output content information from the hard disk unit is expected to be reproduced in a display unit or a speaker. In this case, when the content information recording operation and the content information reproducing operation are both carried out, the content information reproducing operation is affected by the content information recording operation. As a result, the reproduced content information is not smooth. For example, some frames are dropped from a reproduced image at the display unit.

In the above-described prior art content information processing apparatus, in order to avoid a congested state between a content information recording operation and a content information reproducing operation, when reproduction of output content information is expected while input content information is being recorded, the content information recording operation is stopped, which, however, invites an interruption of the recorded content information.

### SUMMARY OF THE INVENTION

It is an object of the present invention to provide an apparatus and method for processing content information capable of reducing the effect of a content information reproducing operation upon a content information recording operation.

According to the present invention, in a content information processing apparatus including a content information inputting section, a content information storage section, a content information reproducing section, and a content information storage section controlling section, the content information storage section substantially time-divisionally carries out a recording operation upon input content information inputted from the content information inputting section for the storage section and a reproducing operation upon output content information in the storage section for the reproducing section.

### BRIEF DESCRIPTION OF THE DRAWINGS

The present invention will be more clearly understood from the description set forth below, with reference to the accompanying drawings, wherein:

FIG. 1 is a block circuit diagram illustrating an embodiment of the content processing apparatus according to the present invention;

FIG. 2 is a block diagram illustrating the software of the CPU and the hard disk controller of FIG. 1;

FIGS. 3, 4 and 5 flowcharts for explaining the operation of the apparatus of FIGS. 1 and 2;

FIGS. 6A and 6B are timing diagrams for explaining the routine of FIG. 3, 4 and 5;

FIG. 7 is another flowchart for explaining the operation of the apparatus of FIGS. 1 and 2; and

FIGS. 8A, 8B, 8C and 8D are timing diagrams for explaining the routine of FIG. 7.

### DESCRIPTION OF THE PREFERRED EMBODIMENT

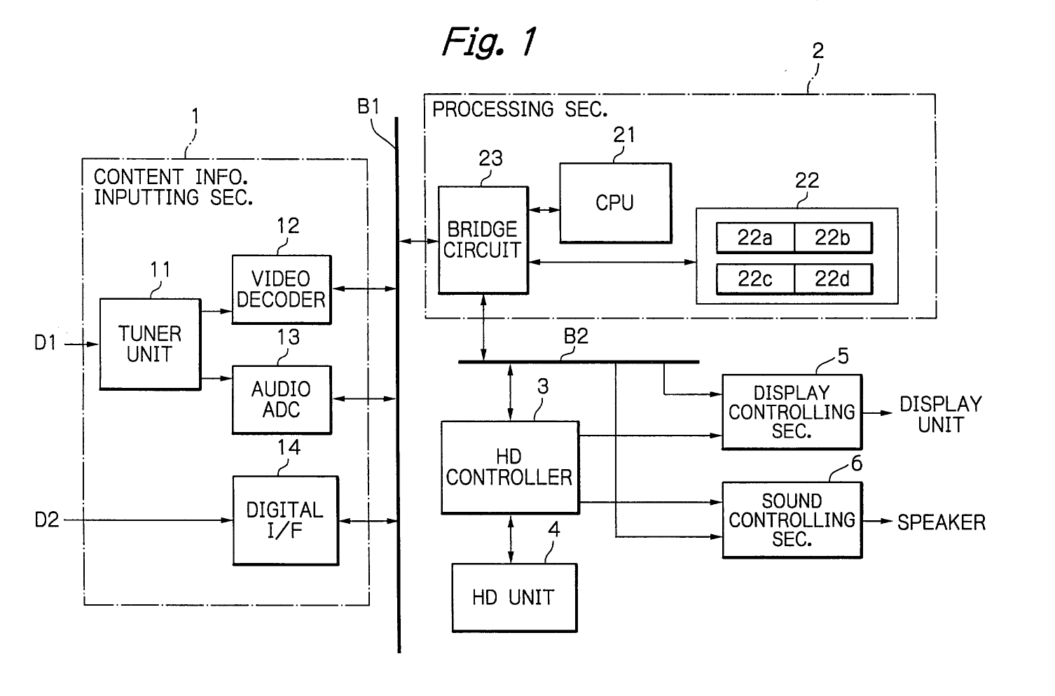

In FIG. 1, which illustrates an embodiment of the content processing apparatus according to the present invention, a content information inputting section 1 is connected via a main bus B1 to a processing section 2 and a hard disk controller 3 for controlling a hard disk unit 4. Also, the processing section 2 is connected via a local bus B2 to the hard disk controller 3. Further, a display controlling section 5 for controlling a display unit and a sound controlling section 6 for controlling a speaker are connected to the local bus B2 and the hard disk controller 3.

The content information inputting section 1 is constructed by a tuner unit 11 for receiving stream data D1 from broadcasting stations or content servers (not shown), a video decoder 12 for decoding a video signal of the stream data D1 at a desired channel, an audio analog/digital (A/D) converter 13 for performing an A/D conversion upon an analog audio signal of the stream signal D1 at a desired channel, and a digital interface 14 such as an IEEE 1394 interface for receiving a digital video/audio signal D2 from a digital tuner or a digital video unit (not shown).

The processing section 2 is constructed by a central processing unit (CPU) 21 for processing the content information such as the stream data D1 and the digital video/audio signal D2, a memory 22 for storing programs, data and the like, and a bridge circuit 23 for carrying out a bus connection, i.e., connections among the CPU 21, the memory 22, the main bus B1 and the local bus B2.

Also, the memory 22 has a buffer 22a, a back up buffer 22b for the buffer 22a, a buffer 22c and a backup buffer 22d for the buffer 22c. Each of the buffers 22a, 22b, 22c and 22d has an n (n=2, 3, . . . ) times capacity as one sector of the hard disk unit 4. In this case, the buffers 22a and 22b are used for a content information recording operation as well as a content information reproducing operation, and the buffers 22c and 22d are used for a content information reproducing operation.

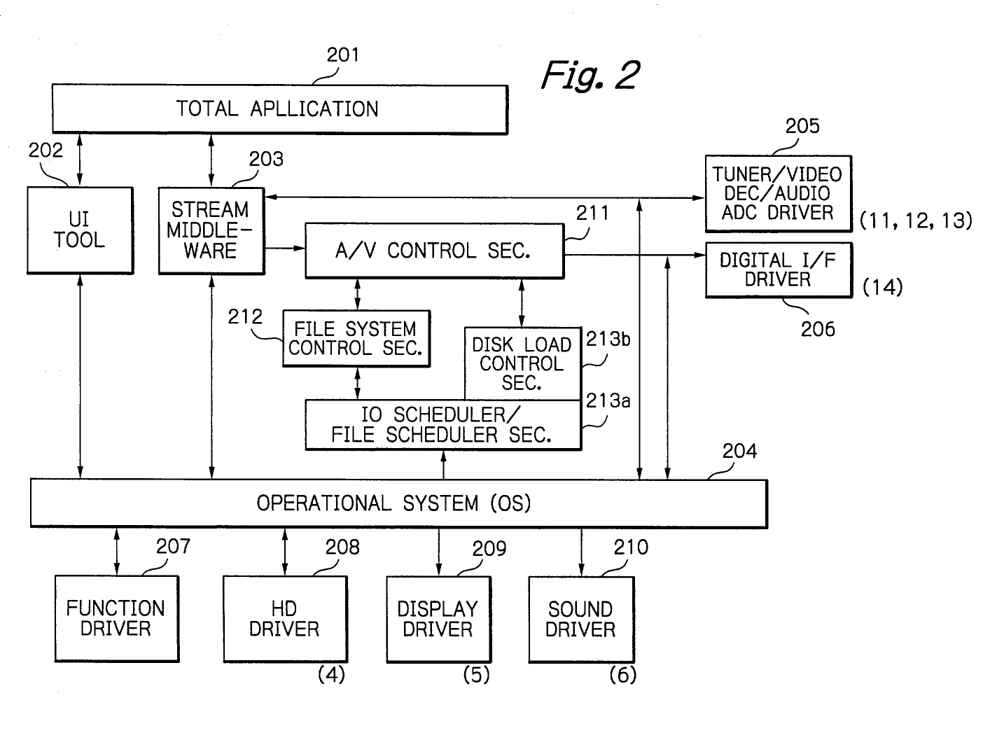

The CPU 21 and the hard disk controller 3 are represented by a software as illustrated in FIG. 2. That is, a total application 201 is operated to record content information in the hard disk unit 4, reproduce content information from the hard disk unit 4, and manage content information stored in the hard disk unit 4. A user interface (UI) tool 202 controls selection information/events at a user interface (not shown). A stream middleware 203 controls stream data of content information, i.e., performs a compressing operation and a ciphering operation thereupon. Also, operational software 204 controls the CPU 21, the memory 22, and various drivers such as a tuner/video decoder/audio ADC driver 205, a digital interface driver 206, a function driver 207 for compressing and ciphering functions, a hard disk driver 208, a display driver 209 and a sound driver 210. Note that the tuner/video decoder/audio ADC driver 205 is middleware provided in the tuner unit 11, the video decoder 12 and the audio A/D converter 13 of FIG. 1. Also, the digital interface driver 26 is middleware provided in the digital interface 14 of FIG. 1. Further, the hard disk driver 208 is middleware provided in the hard disk unit 4 of FIG. 1. Additionally, the display driver 209 and the sound driver 210 are middleware provided in the display control section 5 and the sound controlling section 6, respectively, of FIG. 1.

Further, in FIG. 2, an audio/video (A/V) control section 211, a file system processing section 212, an I/O scheduler/file scheduler section 213 and a disk load section 213 are provided.

The audio/video control section 211 records digital data as content information from the digital interface driver 206 in the hard disk unit 4 and reproduces the digital data from the hard disk unit 4 to the display driver 209 and the sound driver 210. Also, the audio/video control section 211 records stream data as content information from the tuner/video decoder/audio ADC driver 205 via the stream middleware 203 in the hard disk unit 4 and reproduces the stream data from the hard disk unit 4 to the display driver 209 and the sound driver 210.

The file system processing section 212 controls the hard disk unit 4. In more detail, when the file system processing section 212 manages the storage of content information such as stream data and digital data, the file system processing section 212 temporarily stores such content information in the memory 22 to establish a duplex control, thus enhancing the speed of the writing and reading operation of the hard disk unit 4.

The I/O scheduler/file scheduler section 213a and the disk load control section 213b manage the hard disk unit 4, i.e., check the load of the hard disk unit 4 to set the compression ratio/mode.

Usually, when an operation for recording content information such as the stream data D1 or the digital data D2 via the memory 22 in the hard disk unit 4 is carried out simultaneously with an operation for reproducing content information stored in the hard disk unit 4 via the memory 22 to the display controlling unit 5 and the sound controlling unit 6, the content information recording operation is affected by the content information reproducing operation. In order to avoid such a congested state between the content information recording operation and the content information reproducing operation, one approach was to stop the content information recording operation when the content information reproducing operation is being carried out, which may invite an interruption of the recorded content information.

In the present invention, the content information recording operation and the content information reproducing operation can be simultaneously carried out without affecting the content information recording operation.

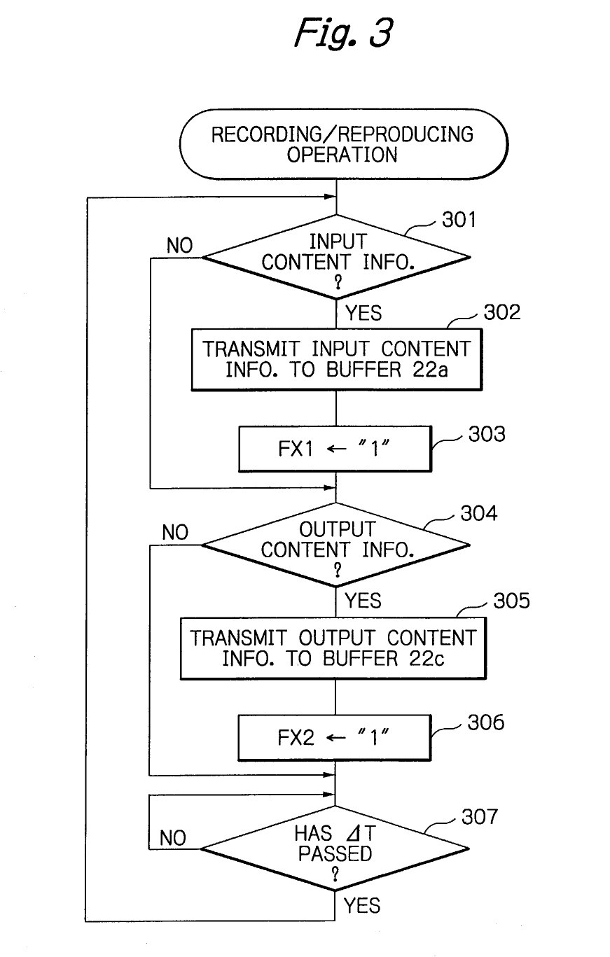

The operation of the CPU 21 and the hard disk controller 3 of FIG. 1, i.e., the operation of the software of FIG. 2 is explained with reference to FIGS. 3, 4A, 4B, 5, 6A, 6B, 6C and 6D.

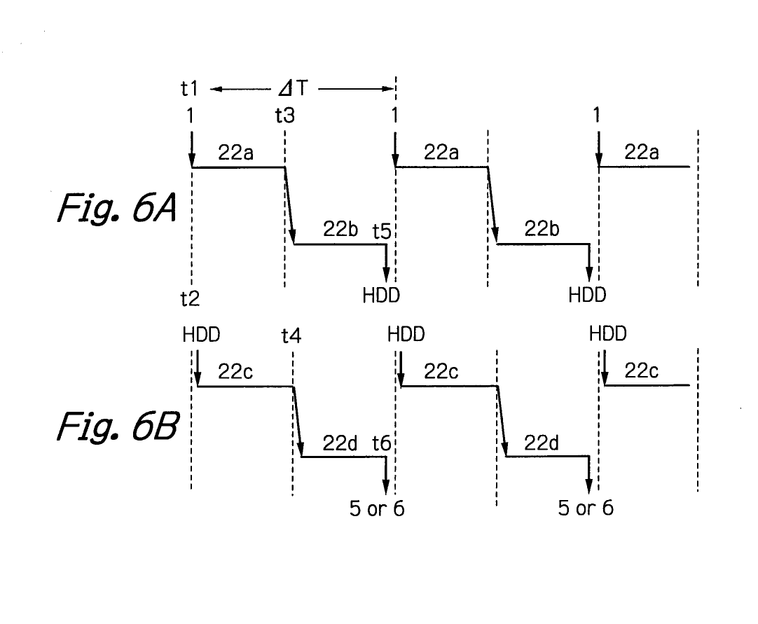

FIGS. 3, 4 and 5 are routines for simultaneously carrying out content information recording and reproducing operations, and FIGS. 6A and 6B are timing diagrams for explaining the routine of FIGS. 3, 4 and 5.

First, at step 301, the hard disk controller 3 determines whether an input content information to be recorded is input to the content information inputting section 1. Only when such an input content information is input, does the control proceed to step 302. Otherwise, the control proceeds directly to step 304.

Next, at step 302, the input content information having an amount of one or more sectors of the hard disk unit 4 is transmitted by the hard disk controller 3 to the buffer 22a (t1 of FIG. 6A).

Next, at step 303, a flag FX1 is set (FX1=“1”) by the hard disk controller 3. Note that the flag FX1 is stored in the memory 22.

At step 304, the hard disk controller 3 determines whether there is any output content information to be reproduced. Only when there is such output content information, does the control proceed to step 305. Otherwise, the control proceeds directly to step 307.

Next, at step 305, the output content information having an amount of one or more sectors of the hard disk unit 4 is transmitted by the hard disk controller 3 to the buffer 22c (t2 of FIG. 6B).

Next, at step 306, a flag FX2 is set (FX2=“1”) by the hard disk controller 4. Note that the flag FX2 is stored in the memory 22.

The control at steps 301 through 306 are repeated by step 307 for every predetermined time period Δt.

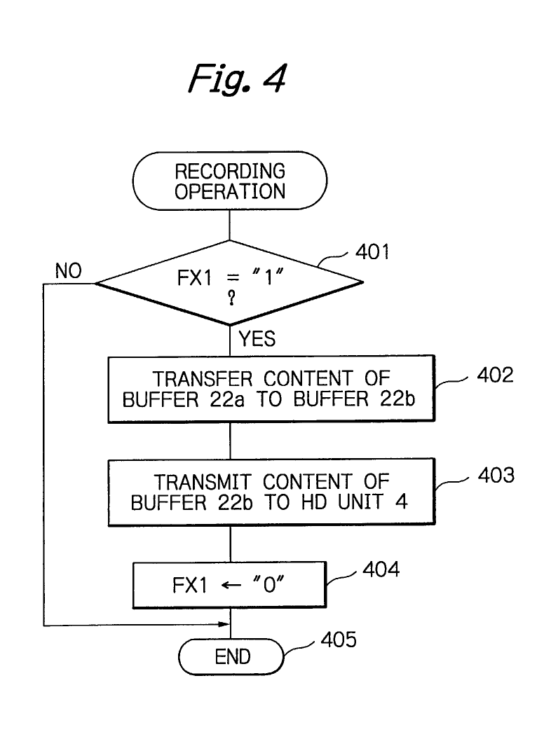

The routine of FIG. 4 is substantially carried out when the flag FX1 is set (FX1=“1”). That is, at step 401, only when FX1=“1”, does the control proceed to steps 402 to 404. Otherwise, the control proceeds directly to step 405.

At step 402, the content of the buffer 22a is transferred by the hard disk controller 3 to the buffer 22b (see t3 of FIG. 6A).

Next, at step 403, the content of the buffer 22b is transmitted to the hard disk unit 4 (see t5 of FIG. 6A).

Next, at step 404, the flag FX1 is reset (FX1=“0”), thus preparing the recording of the next input content information.

Then, the routine of FIG. 4 is completed by step 405.

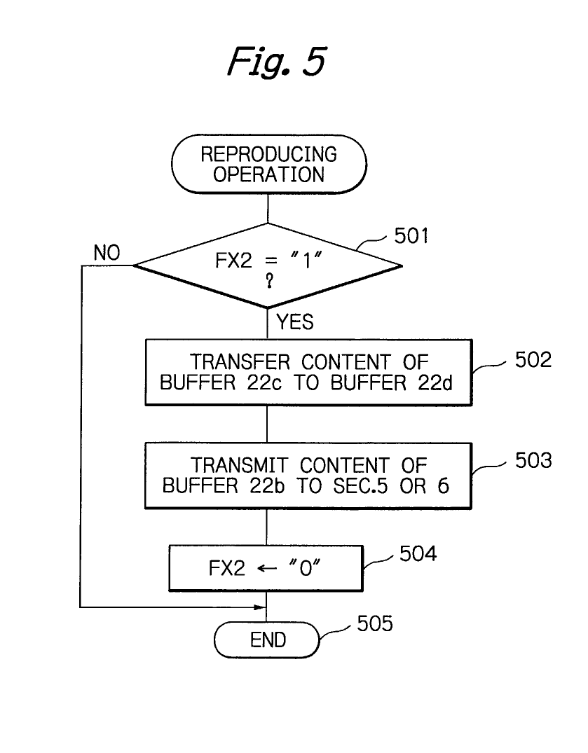

The routine of FIG. 5 is substantially carried out when the flag FX1 is set (FX2=“1”). That is, at step 401, only when FX2=“1”, does the control proceed to steps 502 to 504. Otherwise, the control proceeds directly to step 505.

At step 502, the content of the buffer 22c is transferred by the hard disk controller 3 to the buffer 22d (see t4 of FIG. 6B).

Next, at step 503, the content of the buffer 22d is transmitted to the display controlling section 5 or the sound controlling unit 6 (see t6 of FIG. 6B).

Next, at step 504, the flag FX2 is reset (FX2=“0”), thus preparing the reproducing of the next output content information.

Then, the routine of FIG. 5 is completed by step 505.

Thus, in FIGS. 3, 4, 5, 6A and 6B, since the content information recording operation and the content information reproducing operation are substantially time-divisionally carried out by the hard disk controller 3, i.e., by the software as illustrated in FIG. 2, the content information recording operation is not affected by the content information reproducing operation.

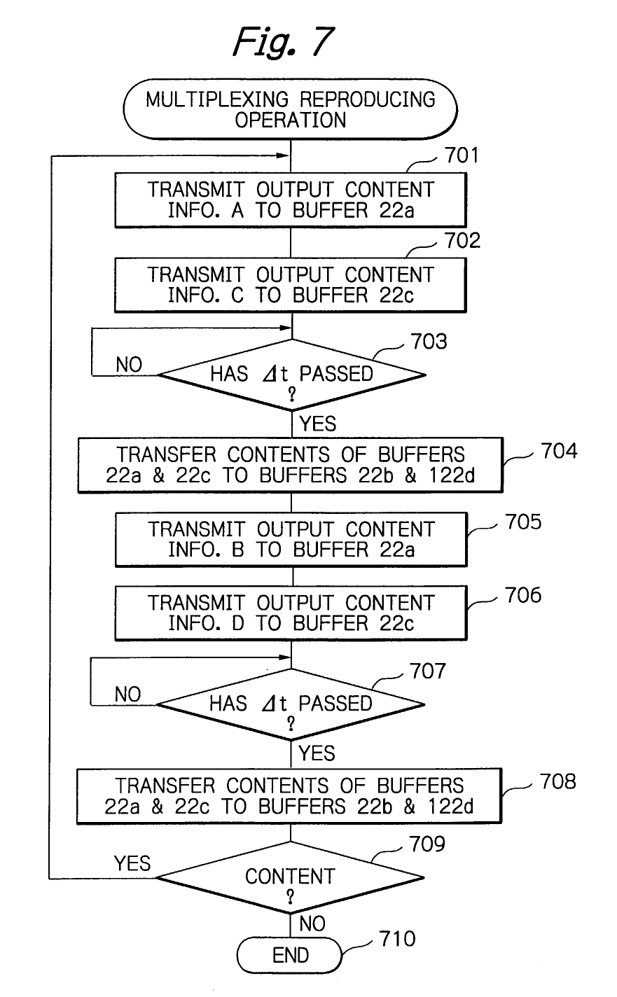

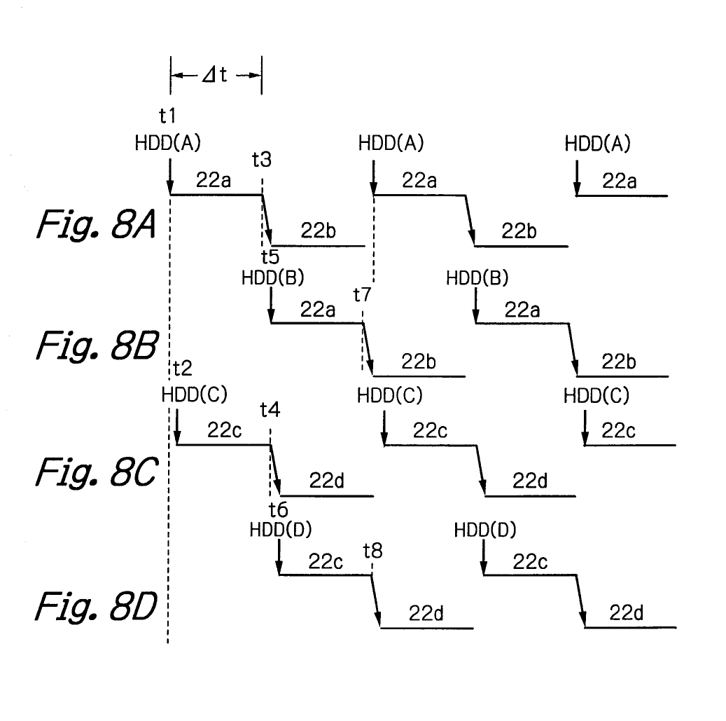

The present invention can be also applied to a multiplexing reproducing operation as illustrated in FIGS. 7, 8A, 8B, 8C and 8D, where four output content information A, B, C and D are reproduced simultaneously for the display controlling section 5.

First, at step 701, one or more sectors of the content information A stored in the hard disk unit 4 are transmitted by the hard disk controller 3 to the buffer 22a (see t1 of FIG. 8A).

Next, at step 702, one or more sectors of the content information C stored in the hard disk unit 4 are transmitted by the hard disk controller 3 to the buffer 22a (see t2 of FIG. 8C).

Next, at step 703, a predetermined time Δt is counted. Only when the predetermined time Δt has passed, does the control proceed to step 704.

Next, at step 704, the contents of the buffers 22a and 22c are transferred by the hard disk controller 3 to the buffers 22b and 22d, respectively (see t3 of FIG. 8A and t4 of FIG. 8C).

Next, at step 705, one or more sectors of the content information B stored in the hard disk unit 4 are transmitted by the hard disk controller 3 to the buffer 22a (see t5 of FIG. 8B).

Next, at step 706, one or more sectors of the content information D stored in the hard disk unit 4 are transmitted by the hard disk controller 3 to the buffer 22a (see t6 of FIG. 8D).

Next, at step 707, a predetermined time Δt is counted. Only when the predetermined time Δt has passed, does the control proceed to step 708.

Next, at step 708, the contents of the buffers 22a and 22c are transferred by the hard disk controller 3 to the buffers 22b and 22d, respectively (see t7 of FIG. 8B and t8 of FIG. 8D).

Step 709 repeats the control at steps 701 through 708 until all content information A, B, C and D are processed.

Then, the routine of FIG. 7 is completed by step 710.

In FIG. 7, every time the contents of the buffers 22a and 22c are transferred to the buffers 22b and 22d, respectively, the contents of the buffers 22b and 22d are transmitted by the hard disk controller 3 to the display controlling section 5, thus displaying the content information A, B, C and D simultaneously.

Thus, in FIGS. 7, 8A, 8B, 8C and 8D, four content information reproducing operations are substantially time-divisionally carried out by the hard disk controller 3, i.e., by the software as illustrated in FIG. 2. For example, four stream data are surely simultaneously displayed in the display unit.

Note that the present invention can be applied to a multiplexing reproducing operation other than a reproducing operation where four content data are reproduced.

As explained hereinabove, according to the present invention, since a content information recording operation and a content information reproducing operation are time-divisionally carried out, the content information recording operation is not affected by the content information reproducing operation. Also, the reproduced content information can be made smooth.

1. A content information processing apparatus comprising:
a content information inputting section;
a content information storage section;
a content information reproducing section; and
a content information storage section controlling section for substantially time-divisionally carrying out a recording operation upon input content information inputted from said content information inputting section for said storage section and a reproducing operation upon output content information in said storage section for said reproducing section.

2. The apparatus as set forth in claim 1, further comprising first, second, third and fourth buffers,
said content information storage controlling section transmitting said input content information from said content information to said first buffer, transferring said input content information from said first buffer to said second buffer, and transmitting said input content information from said second to said content information storage section,
said content information storage controlling section transmitting said output content information from said content information storage section to said third buffer, transferring said output content information from said third buffer to said fourth buffer, and transmitting said output content information from said fourth buffer to said content information reproducing section,
a timing of transmitting said input content information to said first buffer being different from a timing of transmitting said output content information to said third buffer.

3. The apparatus as set forth in claim 2, wherein said content information storage controlling section transmits a plurality of sets of said output content information from said content information storage section to said first and third buffers at different timings, transfers the sets of said output content information from said first and third buffers to said second and fourth buffers, and transmits the sets of said output content information from said second and fourth buffers to said content information reproducing section,
thereby simultaneously displaying the sets of said output content information in said content information reproducing section.

4. The apparatus as set forth in claim 1, wherein said content information storage section comprises a hard disk unit.

5. A content information processing method comprising a step of substantially time-divisionally carrying out a recording operation upon input content information inputted from a content information inputting section for a storage section and a reproducing operation upon output content information in said storage section for a reproducing section.

6. The method as set forth in claim 5, wherein said time-divisional carrying-out step transmits said input content information from said content information to a first buffer, transfers said input content information from said first buffer to said second buffer, and transmits said input content information from a second to said content information storage section,
said time-divisional carrying-out step transmitting said output content information from said content information storage section to a third buffer, transferring said output content information from said third buffer to a fourth buffer, and transmitting said output content information from said fourth buffer to said content information reproducing section,
a timing of transmitting said input content information to said first buffer being different from a timing of transmitting said output content information to said third buffer.

7. The method as set forth in claim 6, further comprising the steps of:
transmitting a plurality of sets of said output content information from said content information storage section to said first and third buffers at different timings;
transferring the sets of said output content information from said first and third buffers to said second and fourth buffers; and
transmitting the sets of said output content information from said second and fourth buffers to said content information reproducing section,
thereby simultaneously displaying the sets of said output content information in said content information reproducing section.

8. The method as set forth in claim 5, wherein said content information storage section comprises a hard disk unit.
